(19) United States
(12) Patent Application Publication
(10) Pub. No.: US 2011/0106342 A1
(43) Pub. Date: May 5, 2011

(54) Absolute angle correction apparatus

(75) Inventor: Chih-Feng Chen, Yilan City (TW)

(73) Assignee: Mark Star Servo-tech Co., Ltd.

(21) Appl. No.: 11/892,996

(22) Filed: Aug. 29, 2007

(51) Int. Cl. G05D 1/00

(52) U.S. Cl. 701/3

(57) ABSTRACT

The instant invention provides an absolute angle correction apparatus for correcting flight angle and direction of a wireless aircraft. The absolute angle correction apparatus includes a controlling signal module, a microcontroller, a transducer module, an output module, and a power module for supplying power. The controlling signal module receives wireless signals from a remote controller, decoding the received wireless signals, and transferring to the microcontroller as original input values. The transducer module measures acceleration and attitude of the aircraft, and transfers measured values to the microcontroller as variation parameters. The microcontroller receives the original input values and the variation parameters, together calculates and outputs precisely computed results. The output module controls flight steering of the aircraft according to the computed result from the microcontroller. The absolute angle correction apparatus corrects flight angle and direction of the aircraft timely and accurately.

### BACKGROUND OF THE INVENTION

(a) Field of the Invention

The present invention relates to an absolute angle correction apparatus, and particularly to a correction apparatus which is used in a wireless model aircraft for correcting flight angle and direction.

(b) Description of the Prior Art

Generally, a wireless model aircraft, such as a remote controlled airplane or a remote controlled helicopter, is controlled by wireless signals from a remote controller to perform in a variety of ways, like speeding up, speeding down, whirling and turning. The aircraft user, who commonly stands on a fixed position of the ground, determines positions of the aircraft only by his/her eyes. View of the user is limited, and therefore, speed, direction and angle of the aircraft viewed by the user may erroneously deviate from true data. The user has to operate the aircraft based on experience, tending to operate inaccurately.

### SUMMARY OF THE INVENTION

An objective of the present invention is to provide an absolute angle correction apparatus which is used in an aircraft for accurately controlling flight direction and angle thereof.

The absolute angle correction apparatus according to the present invention comprises a controlling signal module, a microcontroller, a transducer module coupling with the microcontroller, an output module, and a power module for supplying power. The controlling signal module receives wireless signals from a remote controller, decoding the received wireless signals, and transferring the decoded wireless signals to the microcontroller as original input values. The transducer module measures acceleration and attitude of the aircraft to obtain measured values. The measured values are transferred to the microcontroller as variation parameters for computation of the microcontroller. The microcontroller receives the original input values and the variation parameters, together calculates to obtain computed result, and outputs the computed result precisely. The output module includes a digital server, an analog server and a rotation motor, and is used for receiving the computed results from the microcontroller to control flight, steering of the aircraft.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a block view of an absolute angle correction apparatus according to the present invention.

### DETAILED DESCRIPTION OF THE PREFERRED EMBODIMENTS

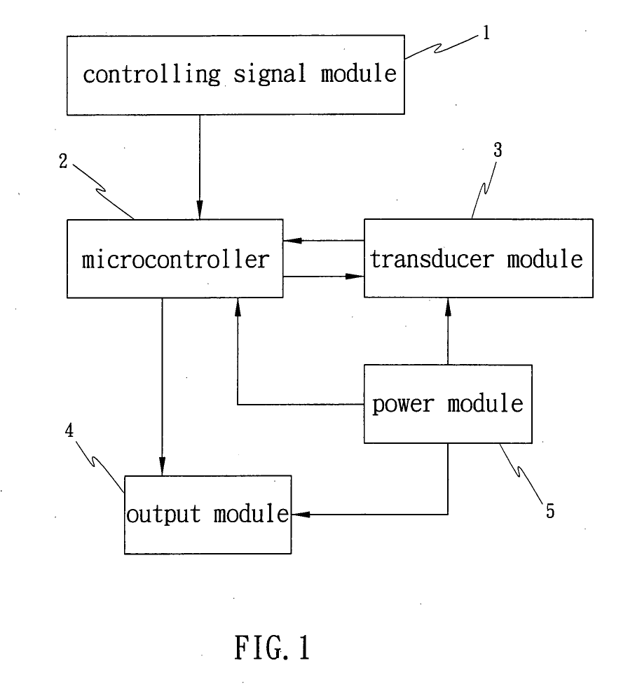

With reference to FIG. 1, an absolute angle correction apparatus in accordance with the present invention comprises a controlling signal module 1, a microcontroller 2, a transducer module 3, an output module 4, and a power module 5 for supplying power. The microcontroller 2 respectively couples with the controlling signal module 1 the transducer module 3, the output module 4 and the power module 5. The power module 5 may be ascending/descending voltage power supply, DC/DC converter, adjuster or power supply etc, which is known to the skilled persons in the field and would not be explained more.

The controlling signal module 1 is used for receiving wireless signals from a remote controller. The wireless signals comprise RF signals ranged of 27 MHz˜5 GHz and complying for legal low power, Bluetooth signals in Bluetooth wireless transmission band, for example 2.4 GHz, infrared signals in infrared wireless transmission band, and etc. The controlling signal module 1 decodes the received wireless signals, and transfers the decoded wireless signals to the microcontroller 2 as original input values.

The transducer module 3 comprises various transducers, such as a multiaxial acceleration transducer, an angle transducer, a direction transducer and a magnetic field transducer. As flight direction and angle of the aircraft vary, states of the transducers vary correspondingly. The transducers of the transducer module 3 measure acceleration and attitude of the aircraft. The measured values of the transducers are transferred to the microcontroller 2 by digital and analog modes, and serve as variation parameters for computation of the microcontroller 2.

The microcontroller 2 is used to receive and calculate together the original input values from the controlling signal module 1 and the variation parameters from the transducer module 3 to obtain computed results. The input values are together decoded, computed, and precisely output to the output module 4. For example, the input values are together computed by parameters comparison and correction.

The output module 4 is used to control flight steering of the aircraft by the computed results from the microcontroller 2. The output module 4 includes a digital server, an analog server and a rotation motor.

The controlling signal module 1 of the absolute angle correction apparatus, receives wireless signals, and decodes the received wireless signals to original input signals. The original input signals of the controlling signal module 1 are transferred to the microcontroller 2. The measured values of the transducer module 3 are transferred to the microcontroller 2 as well. The microcontroller 2 calculates with the original input signals from the controlling signal module 1 and the measured values from the transducer module 3, and precisely transfers to the computed result to output module 4. Thus the aircraft can timely correct flight angle and direction according to diverse flight direction and angle thereof, assuring stable flight thereof.

The absolute angle correction apparatus is utilized mainly based on change of flight direction and angle of the aircraft which are momently detected by the transducer module 3. The measured values of the transducer module 3, including acceleration, angle, direction and magnetic field, are transferred in time to the microcontroller 2. The microcontroller 2 calculates with the original input signals from the controlling signal module 1 and the measured values from the transducer module 3, and achieves the computed result. When the output module 4 receives the computed result from the microcontroller 2, the digital server, the analog server and the rotation motor of the output module 4 accurately control flight steering and power output of the aircraft. Even when an aircraft operator determines the current flight states mistakenly and provides dangerous remote controlling signals with excessive deviation, the absolute angle correction apparatus can compensate and correct in time, assuring the aircraft to fly in accurate angle and direction.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An absolute angle correction apparatus comprising:
a controlling signal module receiving wireless signals from a remote controller, decoding the received wireless signals, and transferring as original input values;
a transducer module measuring acceleration and attitude of the aircraft to obtain measured values, the measured values being transferred as variation parameters;
a microcontroller receiving the original input values from the controlling signal module and the variation parameters from the transducer module, together calculating to obtain computed results, and outputting the computed results precisely;
an output module including a digital server, an analog server and a rotation motor, and receiving the computed results from the microcontroller to control flight steering of an aircraft; and
a power module for supplying power.

2. The absolute angle correction apparatus as claimed in claim 1, wherein the wireless signals comprise low power RF (Radio Frequency) signals ranged of 27 MHz (megahertz)˜5 GHz (gigahertz).

3. The absolute angle correction apparatus as claimed in claim 1, wherein the wireless signals comprise bluetooth signals in bluetooth wireless transmission band.

4. The absolute angle correction apparatus as claimed in claim 1, wherein the wireless signals comprise infrared signals in infrared wireless transmission band.

5. The absolute angle correction apparatus as claimed in claim 1, wherein the transducer module comprises a multiaxial acceleration transducer, an angle transducer, a direction transducer and a magnetic field transducer.
